(19) United States
(12) Patent Application Publication
(10) Pub. No.: US 2004/0248594 A1
(43) Pub. Date: Dec. 9, 2004

(54) Combined multimedia cordless phone and messaging system

(76) Inventor: Paul I. Wren III, Montecito, CA (US)

Correspondence Address: PAUL I. WREN, III, 327 SAN YSIDRO RD, MONTECITO, CA, 93108, US

(21) Appl. No.: 10/455,976

(22) Filed: Jun. 9, 2003

(51) Int. Cl. H04Q 7/20

(52) U.S. Cl. 455/465; 455/426.1; 455/414.1

(57) ABSTRACT

The invention is a multimedia cordless phone and messaging system that uses a broadband Internet Protocol connection to provide an end-user with the ability to record, send, store and receive audio and video content in real time or asynchronously. The invention uses a distributed computing model that places the power-consuming tasks such as disk storage in a wired base station, and uses lightweight full-function rechargeable battery powered handsets that operate wirelessly for convenience throughout the user's location. The base station can be provisioned remotely by the service provider across the Internet, providing ease of use for the consumer. The handsets can be personalized by the end user or the service provider using a common web browser interface on the base station. Multiple phone numbers may be provisioned on the system, with individual handsets configurable to respond to one or more of the numbers provisioned to the base station.

### RELATED US APPLICATION AND PATENT DATA

| | | |
|---|---|---|
| 6,223,029 | Apr. 24, 2001 | Stenman |
| 20030043260 | Mar. 6, 2003 | Yap |
| xxxxxx | May 30, 2003 | Wren |
| 20030041333 | Feb. 27, 2003 | Allen |
| 20020049852 | Apr. 25, 2002 | Lee |
| 6,545,698 | Apr. 8, 2003 | Hong |
| 6,546,241 | Apr. 8, 2003 | Iyengar |
| 20010030950 | Oct. 18, 2001 | Chen |

### BACKGROUND

1. Field of Invention

The present invention relates to communication systems, distributed computing systems, extensible markup languages used to command peer computers with functions and user presentation, and a cordless phone providing both voice and video telephony and asynchronous multimedia messaging.

2. Description of Related Art

Current systems and devices for messaging and voice and video calls have a number of end-user experience limitations. First, multiple devices are required for asynchronous messaging, voice calls and video calls. A PSTN phone is required for voice calls. A PC is required to send and receive high-quality digital images, video and audio. A video phone is required for video calls.

Second, sending a multimedia message as currently implemented with current art is a cumbersome process for an end-user. With conventional current art, the end-user must first transfer video or images from a video or digital camera to a PC using specialized wire connections or utilizing short-range wireless networking devices to transfer multimedia data to a device that can then initiate a connection for send. Furthermore, the end-user experience may further degrade if the size of the data transferred to the PC is significantly large and requires a substantial waiting period to not only send the file to the PC but also to the Internet.

Third, a multimedia mobile phone is capable of sending and receiving photos, audio and video but the quality is extremely low given the low bandwidth constraints of the mobile network. For example, a photo from the current art of a mobile data phone is typically the size of a thumbnail when viewed on a PC and printed on film paper.

Fourth, cordless MMS phones encumber the end-user with fixed message sizes. With fixed message sizes, an end-user must terminate recording when the system determines the end-point as opposed to when the end-user determines that enough multimedia has been collected.

Fifth, the current art of conventional cordless phones provide no level of personalization from a read and write friendly device such as a PC connected to the network. An end-user has limited ability to customize the user interface. In addition, address-book management is cumbersome given that the input means is typically the DTMF keypad. Furthermore, a typical cordless phone is a voice only device and provides no ability to receive requested content such as weather from an external network or originate multimedia messages such as a 10 minute video.

In addition, there are number of technical limitations and inefficiencies with current prior art for messaging and voice and video telephony that ultimately leads to increased costs in units of dollars and time for the service provider and end-consumer. With respect to end-user costs, the current art of emerging 802.11 IP phones and mobile data phones are expensive to manufacture with limited capabilities given the storage constraints of a handheld device that contains not only memory and CPU but also storage and provide limited end-user multimedia experience given the bandwidth constraints of the mobile data networks. Current art 802.11 IP phones are inadequate as end-users seek to originate and save many digital quality multimedia messages from mobile handsets. As message sizes increase, the current IP and mobile handsets must be replaced to store, compose, originate and play larger messages.

Furthermore, new phone number provisioning with the current PSTN requires human intervention to place an order with the PSTN service provider and often physical wire changes to the household. This can be a lengthy and expensive process taking days and even weeks.

Video and call answering has been considered in U.S. Pat. No. 5,896,165, entitled “Method and System for a Video Answering Machine” and Patent Application Number 20030041333 entitled “System and method for automatically answering and recording video calls.” However, these patents define the recipient device as the networking element that terminates the voice or video call to deposit a message. The biggest limitation in this design is not only a lack of reliability and availability but also an inefficient use of the WAN. If the device requires re-initialization, is not powered or is busy, video and call answering is not feasible. This results in the end-user missing a message and the service provider losing revenue earned when call termination does not result. Furthermore, call answering at the termination device is an inefficient use of WAN capacity. There is no need to utilize real-time quality of service capacity for the purposes of depositing a message into the answering device. Instead, the system should terminate the call within the network and transmit the message to the recipient device at lower-latency, quality of service levels. The end-user experience is exactly the same while the service provider benefits from network optimization.

A combined home phone gateway has been considered in US Patent Application 20010030950, entitled “Broadband communications access device.” However, this patent application misses key fundamentals for a mass market combined multimedia phone for voice, video and asynchronous messaging. This patent application does not address the ability to compose a multimedia message of arbitrary length containing voice, video and images from the mobile handset, the ability to personalize the experience of each handset attached to the base-station with preferences for the home deck menu, bookmarks, phone number, ring-tones, screen savers and backgrounds, nor a form factor where the mobile handset provides the end-user with an ability to capture video, audio and images from anywhere within range of the base-station.

Accordingly, what is needed is a system and method for simultaneous voice and video calls and asynchronous multimedia voice, photo and video messaging using a single device that is intuitively simple and highly reliable for the mass market consumer, capable of originating and viewing high-quality images, audio and video and implemented in an effective human form factor that is easy to control, hold and use. What is also needed is a system that is managed by the WAN for high reliability, availability, quality of service and convenience.

### SUMMARY

The primary object of the invention is to provide an end-user with convenient video and voice telephony and asynchronous messaging from a single device using a form factor designed specifically for a consumer household.

The present invention overcomes the end-user experience problems and technical inefficiencies of current voice and video telephony and asynchronous messaging by providing a combined system that links a high speed network such as a DSL or DOCSIS cable network with a base-station and handset that can utilize IP technologies. In the combined system, the base-station and handset provide video and voice telephony and asynchronous messaging in a form factor that is conveniently pervasive throughout a household, reliable to use given the limited power required to interact with a relatively local base-station and free from the miniaturization complexities required for a device that fits into a pocket.

The base-station is the system component that interacts with a WAN using a protocol such as DOCSIS or DSL, provides management and provisioning functionality for the system, enables personalization for the end-user and persistently stores messages and recorded voice and video conversations. The handset is the system component that interfaces with the end-user for data display and collection by linking with the base-station via a LAN enabled wireless link such as 802.11g. A PC is the preferred system component used to personalize the environment for each phone and end-user. Personalization includes the ability to personalize the home deck displayed on the handset, special ring-tones for specific calling parties, screen savers for each handset, and active background images for each handset, handset names, and phone numbers assigned to each handset.

The present invention also provides the end-user with conventional telephony features such as dialing a standard telephone number and multi-party conferences. In addition to standard voice features, the present invention enables the end-user to overlay a video conference to a voice conversation using the same device and form factor. In both use cases, the handset and base-station use IP technology to send and receive data packets that represent visual images or voice samplings from the originating and called parties. Given the use of IP technology, the system is thus capable of sending and receiving multimedia messages that contain voice, images and video using the same link to the WAN. When quality of service is further applied, the system can prioritize real-time traffic packets ahead of latency-tolerant asynchronous messaging packets.

Furthermore, the present invention is designed to be managed and provisioned by the WAN. As a fully managed WAN device, the WAN service provider can ensure a dial-tone level of quality that has come to be expected with the PSTN for not only voice but also video and multimedia messaging. At power on, the base-station interacts with the WAN for configuration attributes such as quality of service and firewall security rules. Following base-station power on, each handset can then power on with personalization and performance attributes as specified by the base-station and, effectively, the WAN service provider.

Given that the system is managed by the WAN and based on IP technologies, an end-user can further request the provisioning of new phone numbers without human intervention. With multiple “soft” phone numbers, the end-user can then personalize phone numbers for each handset or for all handsets. For example, a child can have a personal phone number for her bedroom phone and the family can have a family phone number for the kitchen phone.

For simplicity, the system treats all multimedia messages similarly or, said another way, does not treat a voice mail different than a movie message. In the present invention, a multimedia message is a standards-based message that can be transported via a WAN, played by a standards-based client such as an e-mail client and includes media attachments such as a voice message, photo, 30 second video or a URI that points to a location on the wide area network that contains video that a compatible handset or a PC can stream and play to the recipient end-user.

For cost efficiency, the system is implemented in a distributed computing configuration that places all persistent storage logic in the base-station and all end-user data collection and presentation processing in the handset. By distributing persistent storage to the base-station, the message size and number of stored and recorded messages can grow without forcing the end-user to upgrade a handset with more storage and processing capability. This design also minimizes the manufacturing complexity accompanied with miniaturization by placing storage in a component that can reside in a semi-permanent location in the household.

### BRIEF DESCRIPTION OF THE DRAWINGS

FIG. 1 is a diagram of a communication system with a combined multimedia cordless phone and messaging system. FIG. 1A illustrates the high-level interfaces and components of the system.

FIG. 1B illustrates example implementations of the handset and base-station.

FIG. 2 is a block diagram of physical components of a base-station.

FIG. 3 is a block diagram of physical components of a handset.

FIG. 4 is a block diagram of the software components of a base-station.

FIG. 5 is a block diagram of the software components of a handset.

FIG. 6 illustrates an example handset main menu screen according to the invention. FIG. 6A illustrates a personalized home deck on a handset. FIG. 6B illustrates an active call screen.

FIG. 7 illustrates an example home deck personalization menu according to the invention.

FIG. 8 illustrates an example address-book menu according to the invention.

FIG. 9 illustrates an example display personalization submenu according to the invention.

FIG. 10 illustrates an example settings submenu according to the invention.

FIG. 11 is a flow chart of a method to notify and play new messages on the handset.

FIG. 12 illustrates an example new message notification and message play. FIG. 12A illustrates new message notification on a handset. FIG. 12B illustrates the play screen when an end-user selects to play the message from the new message notification. FIG. 12C illustrates the end-user experience in a conventional e-mail client enabled with inline HTML rendering.

### DETAILED DESCRIPTION OF THE DRAWINGS

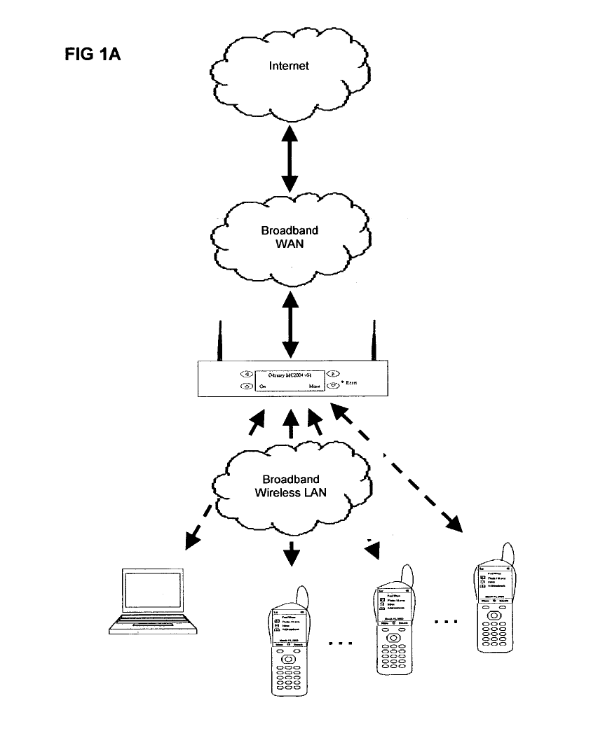

FIG. 1 depicts an example communication system with a combined cordless phone and messaging system. As outlined in FIG. 1A, the system relies on a broadband network such as a DSL or DOCSIS Cable network operatively connected to the Internet. The system includes a base-station connected to the broadband wide area network (WAN) and located at the end-user home or office and one or many handsets connected to the base-station via a local area network (LAN). Generally, the base-station is a consumer electronics device that serves as a hub between the local and wide area network and server for each handset in the LAN. In alternative implementations, the base-station may be embodied more generally as a personal computer, set top cable box, cable modem, DSL modem, wireless hub or firewall.

The handset is also a consumer electronics device that enables voice and video conversations, collects images for photos and video, and presents message data, menus and telephony status such as the active state of a video or voice call. The handset links to the base station via a LAN utilizing a wireless IP link such as 802.11g. When initiating a voice or video call, the handset will establish IP communications directly to the external broadband network via the base-station acting as a hub and router.

Additionally, a PC or laptop is provided in one embodiment to allow an user to personalize the end-user experience for each handset connected to the base station. The PC or laptop connects directly to the base-station using a wire-line or wireless link via the LAN or WAN. Personalization includes home deck settings, new phone number auto-provisioning, bookmark configurations, handset names, ring-tones, screen savers and backgrounds for each handset.

FIG. 1B presents more base-station and handset detail. In this example, the base-station includes a simple LCD and menu buttons for navigation on the front-side and a set of four Ethernet connections and a power jack on the backside. The base-station menu would mainly provide for bootstrap configuration such as “hardcoding” an IP address for the device. In alternative implementations, the base-station may contain other interfaces such as a USB port to interface directly with a PC or LEDs for status instead of an LCD.

A base-station is located any-where convenient within the local area that provides access to high-quality signal strength if connected to the LAN via a wireless link or an Ethernet port. In some implementations, the combined system will be coupled to a DSL or cable modem. In this configuration, the combined system will reside in the device sifting next to the primary wire-line connection to the broadband network.

A base-station operates the link to the WAN and link to one-to-many handsets connected to the base-station. Inbound and outbound operations for the broadband WAN link process many events and data including routing voice and video call requests, routing voice and video IP data packets, and receiving messages containing audio, video and images or URLs that reference multimedia residing on the network, sending multimedia messages on behalf of the Messaging Client in the handset, firewall security and management and provisioning. For inbound messages, the base-station will command the appropriate handset or all handsets to present a notification that will prompt the end-user to play or skip the message. One or many handsets can be assigned one or many phone numbers. For example, the living room phone may be assigned the family number and only ring calls to the family number. A bedroom phone may be assigned another phone number and only ring calls to the specific phone number. Accordingly, the system will only prompt new message notifications for the handsets associated with the recipient phone number. In addition, the base-station will respond to handset initiated requests such as access to the inbox or a root default “home deck” to present at the time the handset is powered on.

A base-station hosts the persistent state logic of the distributed system. Persistent state logic includes data such as the IP address of the device, end-user sub-account data, end-user preferences such as bookmark locations and per-user “home deck” views for each handset, and the file system for the multimedia messages wherein each message may physically reside on a storage device operatively connected to the base-station via a local or wide area link or a hard disk integrated with the base-station.

The handset is primarily an application logic, data presentation, and data collection device. Application logic for the handset includes the voice and video client, messaging client, provisioning and management client and browsing client. Presentation is localized to a language using the internationalization and localization settings of the base-station and displays status, menu options, message views and digital camera lens views of subject matter.

Data collection on the handset occurs through the keypad and digital camera lens. The keypad is used for dialing digits and navigating the menu. Example navigation keys include Left, Right, Down, Up, OK/Enter, Soft Left Button and Soft Right Button. In the example illustration, the camera lens sits on the back of the handset so that the end-user can watch the display showing the image received through the lens on the backside of the handset. The handset also includes a headset jack so that the end-user can carry a voice conversation while pointing the handset at a subject for a photo or video that will be sent simultaneously with the voice conversation.

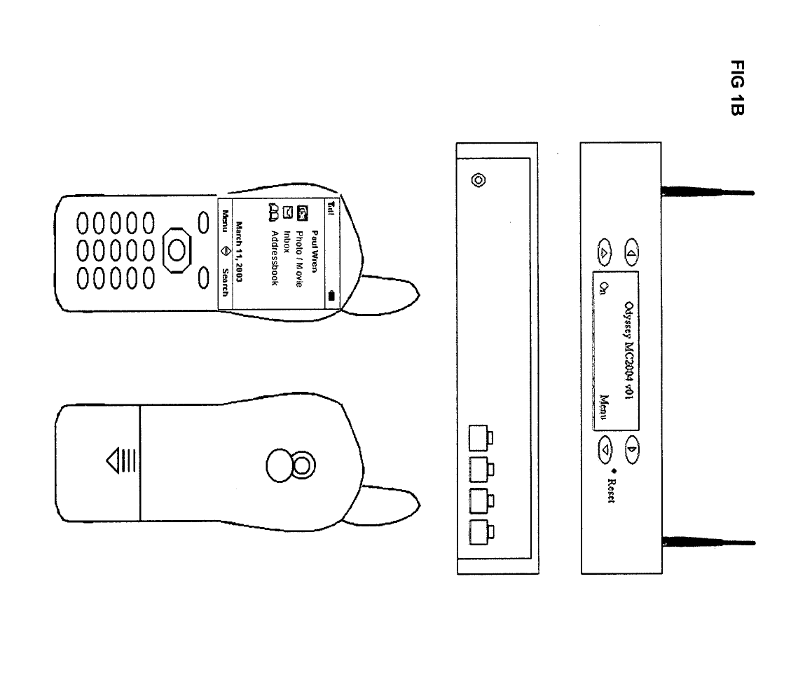

FIG. 2 illustrates a set of device components utilized to enable the base-station. The base-station comprises a host processor, memory, permanent storage, image processor, network interface and display. The host processor may be constructed with conventional microprocessors such as an Intel Pentium processor. The host processor performs functions such as controlling attached components, the network interface, key-pad response and application logic. Example application logic includes notification to the handset when new messages arrive.

The memory provides fast, temporary storage of digital data such as video images and audio. Permanent storage provides persistent storage for recorded video and audio calls, stored inbound messages and stored outbound messages. Permanent storage provides unlimited capacity given that storage can be network attached and the base-station can utilize many network attached permanent storage devices.

The display device may be a low-power LCD for basic configuration such as device reset and the display of version information for the base-station. The LCD may also provide a basic menu for bootstrap configuration such as assigning an IP address to the device.

The network interface links with the broadband network and the LAN using conventional networking technologies such as DOCSIS, DSL, Ethernet and 802.11g. With this link, the handset and base-station will interface using TCP/IP and UDP/IP for the purposes of real-time voice and data communication and asynchronous multimedia messaging.

The base-station utilizes a bus to interconnect various components and provide a pathway for data and control signals. The bus may be implemented with a peripheral component interconnect bus that is standard in many computer architectures.

The base-station may also include a battery recharge slot for a rechargeable battery such as a lithium-ion. This re-charge slot will host a handset battery for recharge and power the base-station in the event of an AC power outage. When a handset battery is depleted, the end-user can exchange the handset battery with the charged battery located in the base-station slot.

The base-station may also include a series of Ethernet ports in the configuration where the base-station acts as a hub for other devices such as a desktop PC located near the base-station.

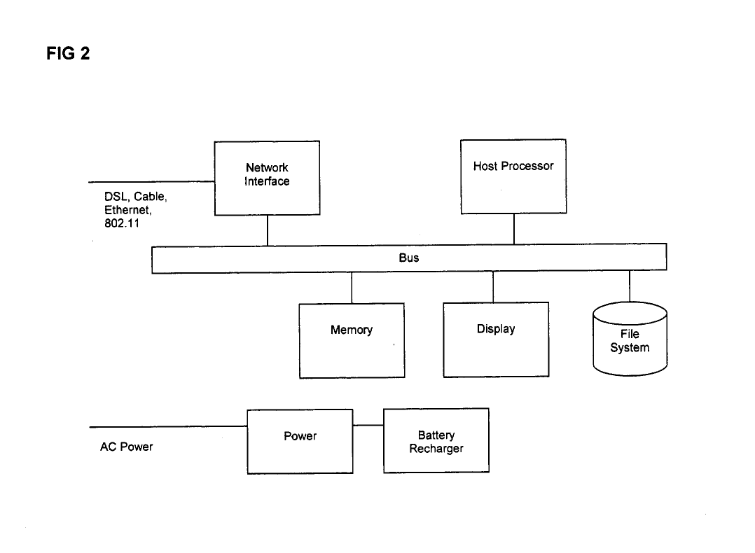

FIG. 3 illustrates a set of device components utilized to enable the handset. The handset is a stateless device that receives all processing commands from the base-station or end-user. The handset utilizes a bus to interconnect various components including a host processor, memory, digital camera, DTMF keypad, display and wireless network interface such as 802.11g.

The host processor may be constructed with conventional microprocessors such as an Intel Pentium processor. The host processor performs functions such as controlling attached components, the network interface, and key pad response.

The image processor serves to encode audio/video signals into a network-compatible data stream for transmission over the network. The image processor also serves to decode a network-compatible data stream received from the network. The image processor may use various algorithms such as MPEG for encoding and decoding video and audio. In some implementations, the host processor will also serve as the image processor.

The display device may be an active matrix LCD for high-resolution display of inbound messages and the GUI used to navigate the system. The LCD may also display screen savers that the end-user may have personalized for the handset when the device state is inactive. An example screen saver is a periodic display of each picture in a designated picture folder residing within the file system. The LCD may also display a background for the GUI when the state is active.

In a preferred implementation, the cordless phone is powered with a rechargeable battery such as a lithium-ion battery that can re-charge via a handset cradle connected to AC power or in a slot hosted by the base-station.

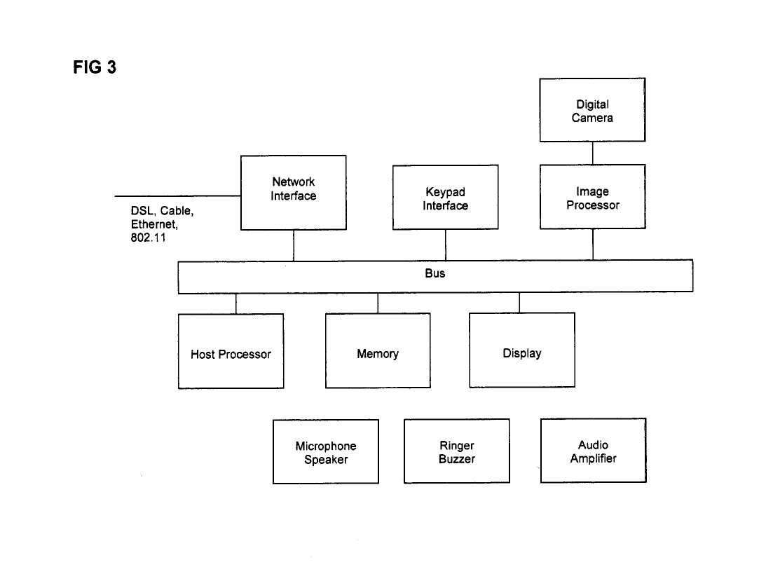

FIG. 4 is a set of software components utilized to enable the base-station. The base-station software architecture includes an Operating System, File System Module, Management and Provisioning Module, Personalization Module and Messaging Module that are loaded from flash memory at power on. The Operating System manages the hardware and software resources on the base-station and provides a consistent means for application modules to interface with the hardware and software components.

The File System Module manages one or many hard disks into a foldering system that the Messaging Module can utilize to save voicemail, photos, movies, recorded voice and video conversations and Personalization Module can utilize to store settings such as the screen saver mode, quality of service settings, and home deck (handset main menu) settings. The hard disks may be network attached or embedded within the device and accessible from other computing devices and operating systems such as a Windows XP enabled PC. The File System Module will also aid the end-user with file system maintenance such as de-fragmenting the hard disk for faster access, adding disk drives for more storage and warning the end-user when low storage conditions exist for the system.

The Management and Provisioning Module enables the automated configuration of the base-station through parameters acquired from the broadband network and handsets through parameters pushed out when a handset broadcasts configuration requests over the LAN. This module also provides network services to the attached handsets. These services may include Domain Naming Services (DNS), IP address assignment upon request, IP address translation, ordering of packets for the purpose of ensuring quality of service based on an application priority and firewall filtering for the purpose of preventing unwanted denial of service attacks from the WAN. The Management and Provisioning Module will also provide diagnostics for testing connectivity and capacity. These diagnostics may be available to the end-user accessing the base-station via a PC or a network operator accessing the device via the WAN. The

Management and Provisioning Module may also provide an online Help and Support function so that the end-user can resolve problems independent of network operator assistance. This function may also provide the end-user with a means to scan the device for critical or functionality updates that may be available from the service provider support system. An example architecture specification for many of the Management and Provisioning functions is provided by the Packetcable CableHome industry forum—CableHome 1.1 Specification.

The Personalization Module provides a means for an end-user to customize the experience of each handset. With personalization, the end-user can set the name, home deck, phone number, ring-tones, screensaver and background for each handset. The Personalization Module also allows the end-user to customize phones for particular purposes and locations in the household. For example, the end-user can personalize a kitchen phone that rings all inbound calls to all numbers hosted by the base-station, presents a screen saver that cycles the favorite family picture album and displays a home deck that includes bookmarks to favorite recipes. Yet further, the Personalization Module could be used to customize phones that belong to the end-user but are attached to a base-station in a distributed location. For example, handset #1 and #2 may reside in house #1 and handset #3 and #4 may reside in house #2.

The Messaging Module is a proxy messaging client to the broadband effectively responsible for send and receive transport when triggered by the network or handset. The Messaging Module terminates notifications from the network, automatically pulls messages within quality of service parameters and priorities, sends messages to the network when requested by the handset and responds to requests for message data such as the display of a folder with all voicemails for 805-555-1212 from one or many handsets. An example implementation of the Messaging Module and Client link is XML-based SOAP over HTTP. An example implementation of the Messaging Module protocol suite to communicate with the WAN is IMAP4 and SMTP as defined by the IETF working group. Another example implementation of the protocol suite used to communicate with the messaging servers hosted in the WAN is WAP 275 and 276 as defined by the OMA.

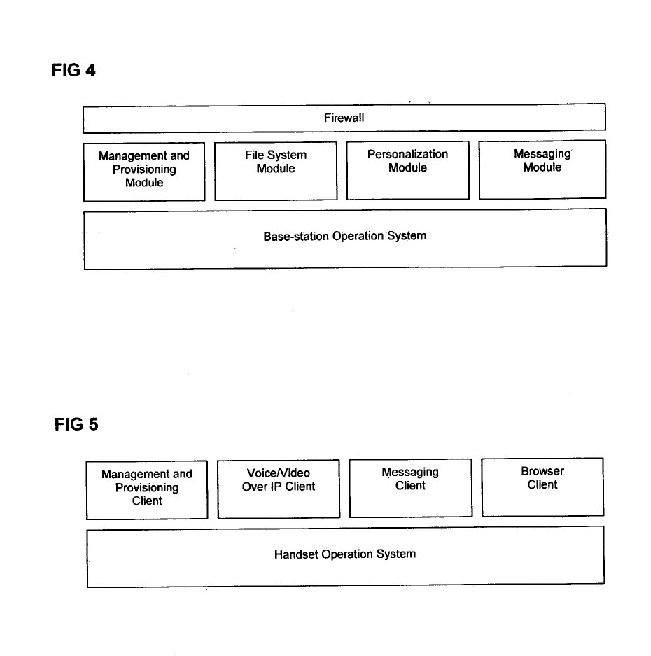

FIG. 5 is a set of software components utilized to enable the handset. The handset software architecture includes an Operating System, Messaging Client, Managing and Provisioning Client, Voice and Video over IP Client and Browser Client that load at power on from flash memory. The Operating System manages the hardware and software resources on the base-station and provides a consistent means for application modules to interface with the hardware and software components. The Operating System provides the main user interface experience presented to the user via the LCD. An example implementation of the Operating System is Windows CE.

The Messaging Client provides standard messaging functions including inbox, reply, reply-all, forward, address-book, delete, compose and send. The Messaging Client proxies interaction with the WAN through the base-station Messaging Module. The Messaging Client is stateless and, thus, links with the base-station Messaging Module to manage the storage and retrieval of messaging data from the file system and send transport to the WAN. A preferred implementation of the Messaging Module and Client protocol is XML-based SOAP over HTTP.

The Management and Provisioning Client provides “dial-tone” initialization for the handset without user intervention. The handset configuration functions initiate at power on by acquiring an IP address and configuration parameters from the base-station configuration service or directly from the WAN and posting device and quality of service attributes to the base-station for reference by the WAN and base-station packet processing. The Management and Provisioning Client will also present the user with error conditions and resolution sequences such as calling the service provider help desk at 1.888.555.1212 or prompting the end-user to upgrade the handset or base-station software. The CableHome 1.1 Specification provides a detailed example implementation.

The Voice and Video over IP Client is the real-time communications module for voice and video conversations. The Voice and Video over IP Client will respond to invitations and connection requests from the network call management system and initiate calls directly to the network's call management system via the base-station acting as a router. Similar to a conventional cordless phone, an end-user can initiate a voice or video call by typing DTMF keys at any point in time. The handset will prioritize DTMF key sequences as dialing instructions requiring immediate response from the handset. The end-user could also initiate the call from an address-book entry for an individual or group of individuals. For calls to a group, the handset will sequence call setup so that the end-user and recipients already on the call can leave a video or voice message to each party that is not available. In addition, the telephony client would enable the end-user to record and save a conversation to the File System Module hosted by the base-station. Furthermore, the voice and video clients may act in an “intercom” mode when calls are placed within a household domain serviced by one or many end-user managed base-stations. In “intercom” mode, each handset within the distributed domain would know of each other and associated capabilities. In a preferred implementation, the end-user could also add calling parties to the address book with a one-touch soft button. Similarly, the end-user could add a calling party to a deny list with a one-touch soft button.

The Browser Client will connect via the WAN to the World-wide Web Internet for web page content associated with an end-user's home deck menu item selected. The Browser client will use standard HTML content as defined by conventional Internet standards. In some implementations, the base-station may transform content to enable a better end-user experience on the handset display. The Browser Client may also provide features to navigate the Internet.

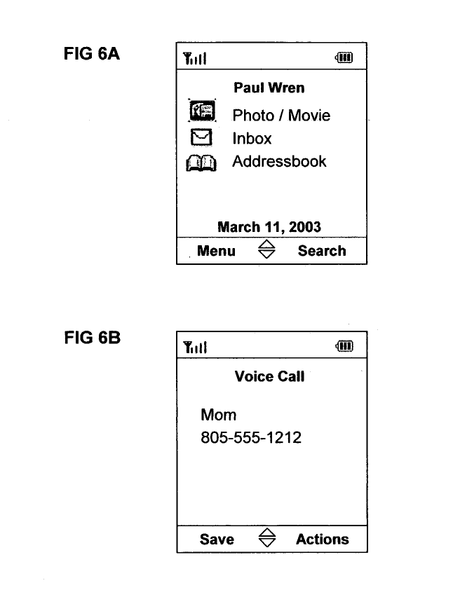

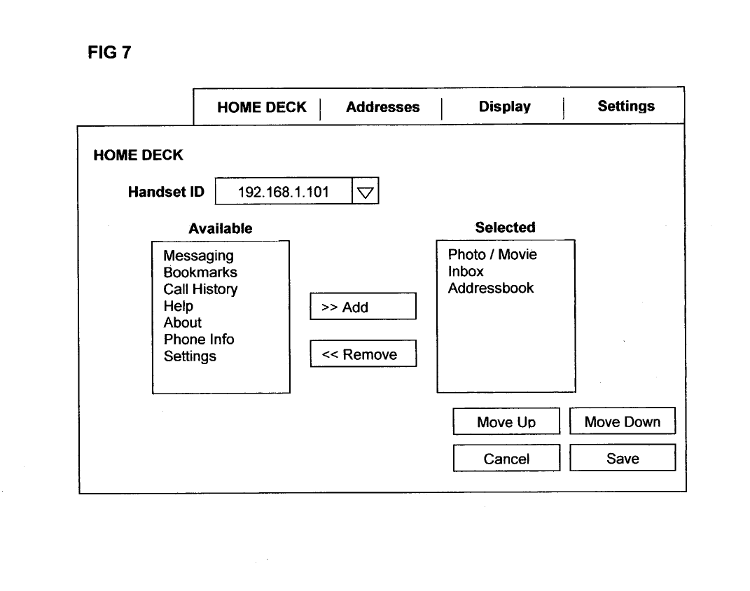

FIG. 6 illustrates an example handset main menu screen according to the invention. At power-on, the handset requests the main menu from the base-station to display to the end-user. The main menu is personalized as described in FIG. 7. As illustrated in FIG. 6A, the main menu includes a name for the handset, three menu options that include photos/movies, address-book and inbox. From this main menu example, the end-user can also access all menu options or search the addressbook through a soft button. The main menu displays a date and time that can be acquired from the WAN. As with all UI screens, an end-user can initiate a conventional phone call through a DTMF sequence that identifies the called party. Once in an active voice call, the handset could display a status screen that would represent the called party's name, phone number, image and options available to the user during the call as illustrated in FIG. 6B. For example, the left soft button could display an option to save the voice discussion to the file system. The right soft button could display a submenu of actions such as initiate a video overlay, conference a 3^{rd} party into the call or hold the call.

FIG. 7 illustrates a submenu associated with personalizing the home deck or main menu of each handset that is displayed at power on or when a new user logs onto the handset. The submenu could apply home deck personalization for a specific handset, all handsets, a specific phone number or a user of the base-station system. In the illustration, the submenu organizes personalization by the Handset ID.

The Available menu lists options, further submenus and actions available to the end-user as enabled by the handset. In this example, home deck options include handset name, bookmarks, call history, date and time, inbox, photos/movies, help and support and about. The Selected menu lists items selected for the home deck. For the selected home deck items, the end-user can also select the order on the home deck by moving specific line items up or down. The menu options, submenus and actions are, of course, dependent on device capabilities.

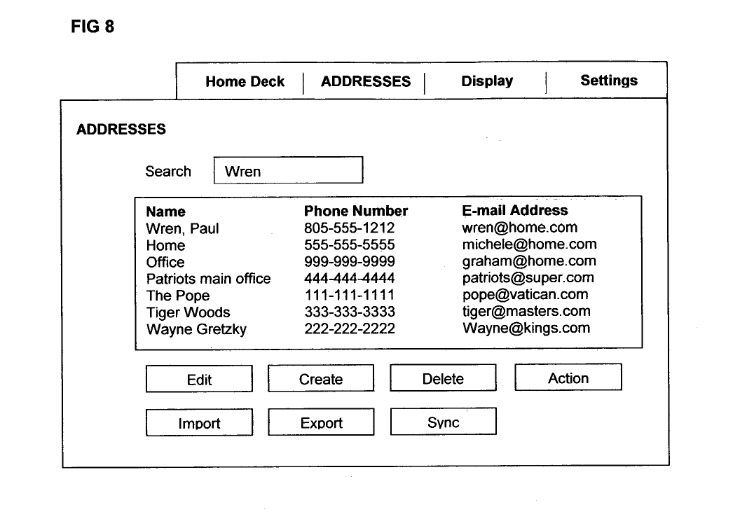

FIG. 8 illustrates a submenu to manage the address-book for the combined system. The address-book includes standard electronic address-book features such as search, edit, create, action for calling, delete, import, export and sync with other address-books connected to the Internet. The address-book would also include the capability to add a group of entries such as four college friends. The primary benefit to the end-user is the ability to manage the address-book using a PC format factor and use the address-book from a handset form factor.

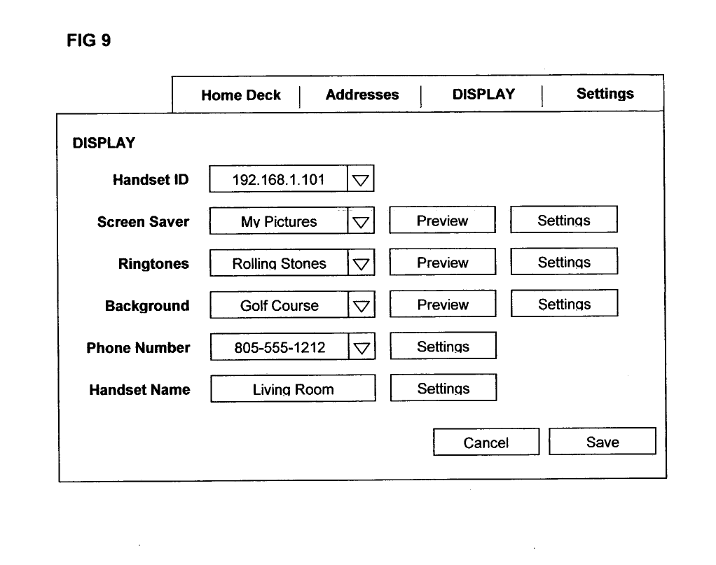

FIG. 9 illustrates a submenu to personalize the display for each handset at power on or when a new user logs onto the handset. Handset display personalization is not only visual but also audio. The submenu could apply display personalization for a specific handset, all handsets, a specific phone number or an user of the system. In the illustration, the submenu organizes personalization by the handset ID. Alternative implementations could organize this submenu by phone number or user ID.

Display settings allow an end-user to set ring-tones for incoming calls based on the caller-id (known, unknown) or called number, backgrounds, screen savers, phone numbers and names. Ring-tones can be unique audio clips downloaded from the network or shipped in the default configuration. Ring-tones are played for each phone number assigned to the handset for incoming calls with a caller-id that matches the ring-tone setting. If a matching ring-tone is not discovered, the device will play the default ring-tone.

Backgrounds can be unique pictures or designs downloaded from the network or shipped in the default configuration of the device. The background is displayed in the background to the home menu and handset UI when the handset is active.

Screensavers can be unique slide shows of a picture folder or visual images downloaded from the network or shipped in the default configuration of the device. The screensaver is displayed when the handset reaches an idle state as configured by the end-user or the default settings. A preferred default screensaver will cycle through a picture album and overlay new message indication for each end-user configured in the base-station.

Names can be unique such as “Living Room” or “Gordon's Room” as defined by the end-user for each handset. Names will be placed into the address-book for further reference.

One or many phone numbers can be assigned to each handset depending on the phone numbers provisioned by the WAN. Ring-tones and new message notifications will trigger as appropriate for each phone number assigned to the handset. The end-user can request new phone number provisioning via the Settings submenu.

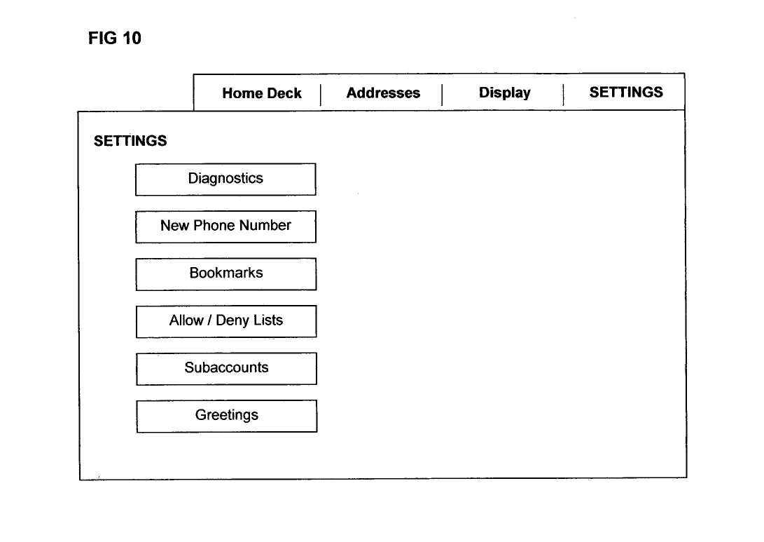

FIG. 10 illustrates a submenu to specify settings for the whole system. Example applications that may exist for system settings include diagnostics for trouble shooting, bookmarks to select Internet applications such as weather of the day to place onto a home deck, allow/deny lists to control the incoming messages and calls that a handset or the entire system can receive, new phone number requests from the network, reboot, personalized greetings, sub-account management so that many users can share a phone number while still having a separate inbox for photos, voice mail, and movies and help and support so that an end-user can download and install upgrades and new applications, search a knowledge base or scan for critical updates to apply to the device.

The Diagnostics function will enable the service provider or the end-user to test the connectivity and quality of the WAN connection and the connectivity and quality of the link with each IP handset. Diagnostics results will provide for trouble shooting input and resolution.

The Bookmark function would be a link to a network-based web page that lists interesting, fun and entertaining bookmarks to place into the home deck. Example bookmarks include recipes for kitchen phones, breaking news for the master bedroom and funny stories for the bathroom phone. The end-user could also navigate the Internet and select a site as a favorite bookmark.

Once selected as a favorite, the site would appear as an option in the home deck personalization available menu. A default network page would ship with the phone and point to the phone manufacturer site such as www.wrenphone.com/bookmarks. In addition, a service provider could provision a new network link pointing to an operator site such as www.serviceprovider.com/bookmarks.

The Allow and Deny function will enable the end-user to control the inbound calls and messages that can access the device. Allow lists assume that all calls and messages are blocked except the calls and messages from a specified From: address or caller-id. Deny lists assume that all calls and messages are allowed except the calls and messages from a specified From: address or caller-id. If blocked, the end-user could enable an option to forward the call to another messaging system or drop the call or message completely.

The New Phone Number function will provide the end-user with a means to request and automatically provision on a new phone number from the network. The function will submit a request to the network and process the response. Error conditions will prompt a call into the support and help desk. Successful responses will result in a phone number allocated to the base-station that the end-user can then assign to a handset via the Display settings submenu.

The Personalized Greeting function would apply personalized voice and video prompts to the WAN for the broadband answering server to play to a calling party on busy or no answer conditions. Other greeting settings include a called party tree for each phone number. The called party tree for each phone number would allow a calling party to leave voice and video messages for a specified end-user sharing a phone number. For example, a calling party could select 1 to leave a message for Paul and 2 to leave a message for Mary Lee.

The Subaccount function will provide the end-user with a means to define User IDs and passwords for the base-station and personalization for each User ID and Password. There will be one head of household for the device. Each handset ideally is configured to default to head-of-household settings. In addition to the head-of-household, there can be many users sharing one handset or many users sharing many handsets. Personalization could be managed on a per user basis as opposed to per handset basis. If greetings are configured to segregate messages for each user in the system, a virtual file and folder system will be maintained for each user. Each end-user would access their messages by logging onto a device with the User ID and password. Once logged into the handset, the handset would utilize the settings associated with the user ID and password.

The Help and Support function will provide trouble shooting routines, service provider support web pages and a support desk number. This function would also enable the end-user to scan the base-station and handsets for the latest versions of software and prompt the user to update the software when new features or critical updates are available for download and installation.

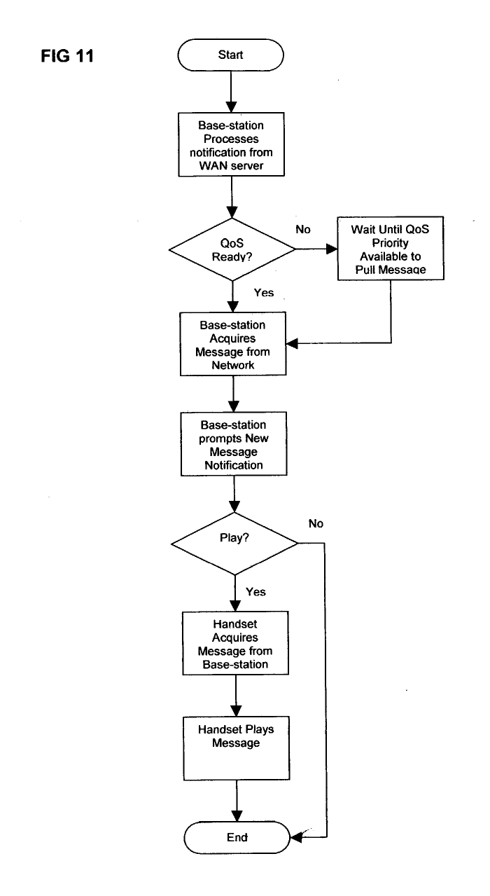

FIG. 11 is a flow chart of a method to receive a message. Message receipt begins with the base-station receiving a notification from the WAN messaging server that new messages exist for a particular user or users sharing a phone number. Once the notification is received, the messages are pulled from the network messaging server within the quality of service constraints applied to the base-station. For example, the automatic pull will not degrade an ongoing voice or video conference and will defer processing until capacity is available. Once the message or messages are local, the base-station will notify the appropriate handset or all handsets of the new message.

From the new message notification, the end-user can then choose to play the message or skip viewing the message until a more convenient time. If the end-user selects to play the message, the handset pulls the selected message from the base-station and plays the content. Once the play is complete, the end-user can perform standard message functions such as reply, reply-all, forward, delete, or save. At any point, the end-user can navigate the inbox to view new and read messages that have not been deleted or saved to a separate folder.

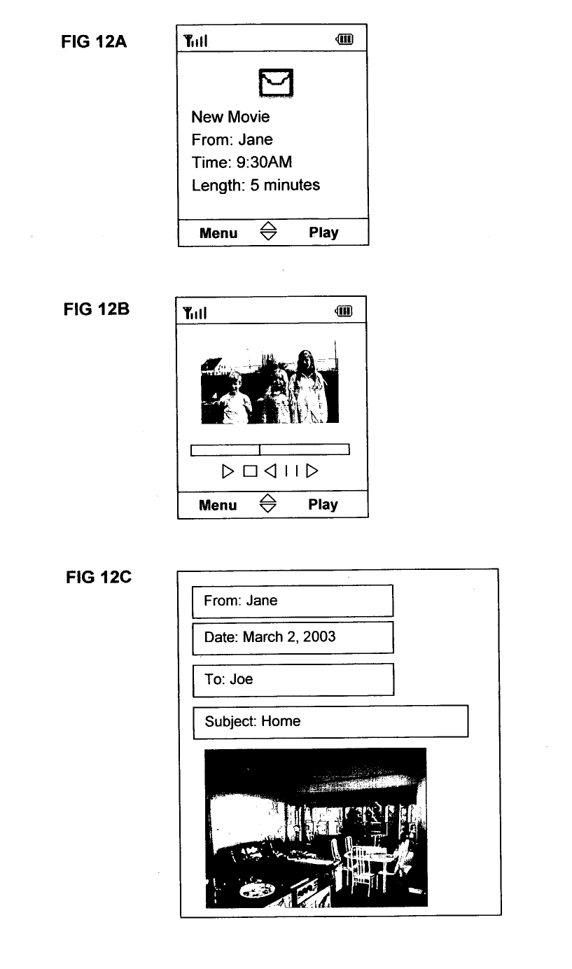

FIG. 12 is an example end-user experience for a handset presented with a new message notification and automatic play from a small device form factor such as this invention and a larger form factor messaging client such as an e-mail client hosted on a PC. FIG. 12A presents the new notification and the options available to the end-user. User interface attributes in this example include type of message, from address, time received, message length, menu soft button and play soft button. FIG. 12B presents the automatic play of a photo message from a handset. A play experience could present the end-user with VCR controls such as stop, play, fast-forward and replay. Other features include pause and a menu soft button for further action such as delete or forward. FIG. 12C presents automatic play of the photo message from an e-mail client with the ability to present inline images. Example e-mail clients include Microsoft Outlook Express utilizing a local Windows application technique and Hotmail using a web page technique.

What is claimed is:

1. A system providing voice and video telephony and asynchronous messaging comprising a cordless phone handset and base-station.

2. The system of claim 1 wherein the base-station comprises a transceiver for forming IP communications links with a local area network (LAN) and wide area network (WAN), messaging module for originating and receiving voice, video, audio and image messages to and from the WAN and via the LAN on behalf of the messaging client residing in the handset, personalization module enabling the end-user to configure default settings for the handset display and telephony module behavior and file system for storing received and sent messages and recorded video and voice conversations on a hard disk embedded or network-attached to the base-station, management module for configuring and provisioning the device at power on, display enabling the end-user to view device status and basic configuration and buttons or controls for navigating the device menu.

3. The system of claim 1 wherein the handset comprises a display enabling the end-user to view messages, options and telephony status via a browser-based GUI, a digital camera, a flash, a transceiver for forming IP communications links between the handset and network, a standard DTMF key interface, soft buttons for navigating the GUI and controlling the base-station, a wireless headset, video, audio and imaging digital signal processing module browsing client for navigating web pages, messaging client with standard functionality that controls the base station messaging module, management module for configuring and provisioning the device at power on, and voice and video client for real-time conversations.

4. The system of claim 1 wherein the telephony and messaging modules provide voice, video and messaging capabilities over a broadband wide area networking connection such as DSL or Cable DOCSIS and the handset network interface with the base-station uses the same networking protocols over a wireless link such as IEEE 802.11g.

5. The system of claim 3 wherein the messaging client provides standard messaging functions including address-book, notification, compose, reply, reply-all, forward, delete, slow, fast and normal play, pause, save and send for all types of multimedia messages containing voice, images and video and references to messages accessible via the base-station WAN or LAN interface that the handset can stream to the handset display.

6. The system of claim 5 wherein the end-user can establish a group video call, voice call or multimedia message send from an address-book entry wherein a group is a set of many called parties or message recipients.

7. The system of claim 2 wherein the network-based messaging system notifies the base-station messaging module that new messages exist and, the messaging module retrieves new messages from the network-based messaging system when the quality of service characteristics allow the messaging module to do so.

8. The system of claim 2 wherein the personalization module enables the end-user to control default base-station settings such as home deck applications and bookmarks representing locations on the Internet as displayed on the handset initial presentation to the end-user, ring-tones associated with specific caller-ids, screen savers for display when the device is idle, background screens for display when the device is in-use, accounts on the device for organizing messages into files that are only visible to the active account, auto-provisioning new phone numbers from the network, address-book management that includes import, synchronization, create, edit, access control and delete and personal greetings for the network to play to calling parties when the device is in a no-answer or forward condition for the purposes of prompting for voice and video message deposits.

9. The system of claim 8 wherein the personalization module is controlled from a PC, handset or other device connected to the network using a browser-based application.

10. The system of claim 2 wherein the base-station is managed and provisioned by WAN services residing on the network operatively connected to the base-station.

11. The system of claim 3 wherein the handset is managed and provisioned by the base-station operatively connected to each handset via the LAN.

12. The system of claim 2 wherein the system may be embodied or coupled with other networking elements such as a DSL modem, cable modem, wireless hub and router or PC.

13. The system of claim 1 wherein the system is a distributed computing environment that distributes data collection and presentation processing to the handset and persistent storage processing of message, recording and configuration data to the base-station.

14. The system of claim 13 wherein the handset is stateless or does not maintain status of previous events such as messages sent or calling history and acquires all processing commands from the end-user, base-station or network.
